(19) United States
(12) Patent Application Publication
(10) Pub. No.: US 2026/0225824 A1
(43) Pub. Date: Aug. 6, 2026

(54) CONVEYOR-BASED SYSTEMS AND METHODS FOR REORIENTING PACKAGING CONTAINERS

(71) Applicant: Walmart Apollo, LLC, Bentonville, AR (US)

(72) Inventors: Gerald J. Byers, Springfield, MO (US); Tomas A. Blodgett, Fayetteville, AR (US); Sean N. Pittman, Rogers, AR (US)

(21) Appl. No.: 19/042,487

(22) Filed: Jan. 31, 2025

(51) Int. Cl. B65G 47/248; B65G 43/08

(52) U.S. Cl. CPC B65G 47/248; B65G 43/08; B65G 2201/025; B65G 2203/041

(57) ABSTRACT

Systems and methods for orienting boxes to ensure they are positioned right side up as they move along a conveyor utilize one or more rotation chambers that rotate the boxes in 90-degree increments. The location of the boxes in the rotation chambers and the rotation direction of the rotation chambers is selected to prevent tumbling of the boxes during the rotation. Sensors may detect the orientation of the boxes moving on the conveyors to determine the number of rotations necessary to reorient the box such that the box is oriented with the correct side up, and the conveyor may be caused to precisely align the box with appropriate corner of the rotation chamber. The system can include multiple rotation chambers in series, allowing for the boxes to be rotated 90, 180, or 270 degrees, and includes sensors to verify the orientation of the boxes prior to and after the rotation.

### TECHNICAL FIELD

This disclosure relates generally relates to conveyor-based systems and, more particularly, to conveyor-based systems that move packaging containers.

### BACKGROUND

In various industries that involve packaging products into containers and moving the containers on conveyors, it is often necessary to reorient containers to such that they are oriented with the correct (i.e., right) side up. Traditional methods of reorienting containers may involve human workers and/or robotic arms that manually reorient each box and can be inefficient and prone to errors, leading to increased operational costs and reduced productivity and processing speeds. Accordingly, there is a need for a conveyor-based system that can accurately and efficiently reorient containers to orient the containers right side up.

### BRIEF DESCRIPTION OF DRAWINGS

Disclosed herein are embodiments of systems, apparatuses and methods pertaining to reorienting containers moving on conveyors. This description includes drawings, wherein:

FIG. 1 is a perspective view of a system of a conveyor-based system including rotation chambers for reorienting containers moving on conveyors in accordance with some embodiments.

FIG. 2A is a front elevational view of an example rotation chamber block in accordance with some embodiments, shown with a container positioned within the rotation chamber prior to rotation of the container;

FIG. 2B is a front elevational view of the example rotation chamber block of FIG. 2A, shown with the container positioned within the rotation chamber after the rotation of the container;

FIG. 3A is a front elevational view of an example rotation chamber block in accordance with some embodiments, shown with a container positioned within the rotation chamber prior to rotation of the container;

FIG. 3B is a front elevational view of the example rotation chamber block of FIG. 3A, shown with the container positioned within the rotation chamber after the rotation of the container;

FIG. 4A is a front elevational view of an example rotation chamber block in accordance with some embodiments, shown with a container positioned within the rotation chamber prior to rotation of the container;

FIG. 4B is a front elevational view of the example rotation chamber block of FIG. 4A, shown with the container positioned within the rotation chamber after the rotation of the container;

FIG. 5 is a schematic block diagram of a system of a conveyor-based system including rotation chambers for reorienting containers moving on conveyors in accordance with some embodiments;

FIG. 6 is a block diagram of a computing device in accordance with some embodiments;

FIG. 7 is a flow diagram of a method of reorienting containers moving on conveyors in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments. Also, common but well-understood elements that are useful or necessary in a commercially feasible embodiment are often not depicted in order to facilitate a less obstructed view of these various embodiments. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of example embodiments. Reference throughout this specification to “one embodiment,” “an embodiment,” “some embodiments”, “an implementation”, “some implementations”, “some applications”, or similar language means that a particular feature, structure, or characteristic described in connection with the embodiment is included in at least one embodiment. Thus, appearances of the phrases “in one embodiment,” “in an embodiment,” “in some embodiments”, “in some implementations”, and similar language throughout this specification may, but do not necessarily, all refer to the same embodiment.

Generally speaking, pursuant to various embodiments, systems, apparatuses, and methods are provided herein useful for reorienting boxes to ensure that they are positioned in a desired orientation as they move along a conveyor utilize one or more rotation chambers that rotate the boxes in 90-degree increments. The location of the boxes in the rotation chambers and the rotation direction of the rotation chambers is selected to prevent tumbling of the boxes during the rotation. Sensors may detect the orientation of the boxes moving on the conveyors to determine the number of rotations necessary to reorient the box such that the box is oriented with the correct side up, and the conveyor may be caused to precisely align the box with appropriate corner of the rotation chamber. The system can include multiple rotation chambers in series, allowing for the boxes to be rotated 90, 180, or 270 degrees, and includes sensors to verify the orientation of the boxes prior to and after the rotation.

In some embodiments, a system for reorienting containers moving on conveyors includes a conveyor including a product advancement surface that supports a container thereon to advance the container in at least a first direction, as well as at least one rotation chamber that rotates in 90-degree increments. The container travels on the product advancement surface of the conveyor located upstream of the at least one rotation chamber and into an interior of the at least one rotation chamber. After the container is located in the interior of the at least one rotation chamber, the at least one rotation chamber makes a 90-degree rotation to reorient the container by 90 degrees relative to an original orientation of the container, and after the at least one rotation chamber makes the 90-degree rotation to reorient the container by 90 degrees, the at least one rotation chamber advances the container from the interior of the at least one rotation chamber onto the product advancement surface of the conveyor located downstream of the at least one rotation chamber.

In some embodiments, a method of reorienting containers moving on conveyors includes: advancing a container on a product advancement surface of a conveyor and from the product advancement surface located upstream of at least one rotation chamber into an interior of the at least one rotation chamber; rotating, after the container is located in the interior of the at least one rotation chamber, the at least one rotation chamber by a 90-degree rotation to reorient the container by 90 degrees relative to an original orientation of the container; and advancing, after the rotation of the at least one rotation chamber by the 90-degree rotation to reorient the container by 90 degrees via the at least one rotation chamber, the container from the interior of the at least one rotation chamber onto the product advancement surface of the conveyor located downstream of the at least one rotation chamber.

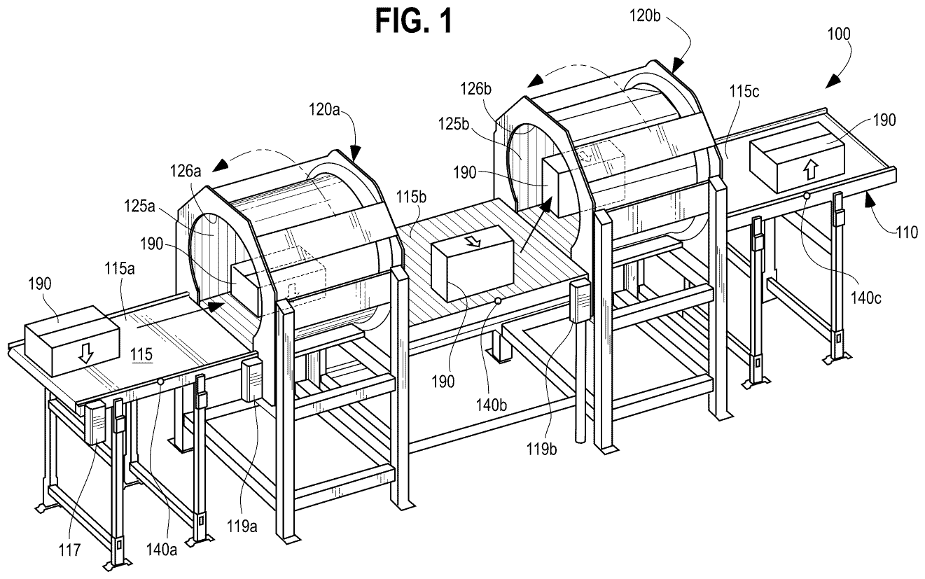

FIG. 1 illustrates a system 100 for reorienting containers 190 moving on a conveyor 110. The conveyor 110 has a product advancement surface 115 that supports multiple containers 190 thereon while advancing the containers 190 in a direction shown by the directional arrows in FIG. 1. The product advancement surface 115 of the conveyor 110 may include a single conveyor belt surface (horizontal (as shown) or inclined), or may be instead comprised of a series of two or more independently movable conveyor belt surfaces (horizontal or inclined).

The conveyor 110 may be a belt conveyor, chain conveyor, or the like and may have a continuous, uninterrupted product advancement surface 115, or may have a product advancement surface 115 that includes one or more interruptions at the transitions between the distinct conveyor surfaces. In some embodiments, the product advancement surface 115 of the conveyor 110 may include skewed rollers, omnidirectional wheels, or mechanical actuators to cause the container 190 to travel on the product advancement surface 115 in at least two different directions (e.g., in a first direction and a second direction perpendicular to the first direction, in a first direction and a second direction diagonal relative to the first direction, etc.).

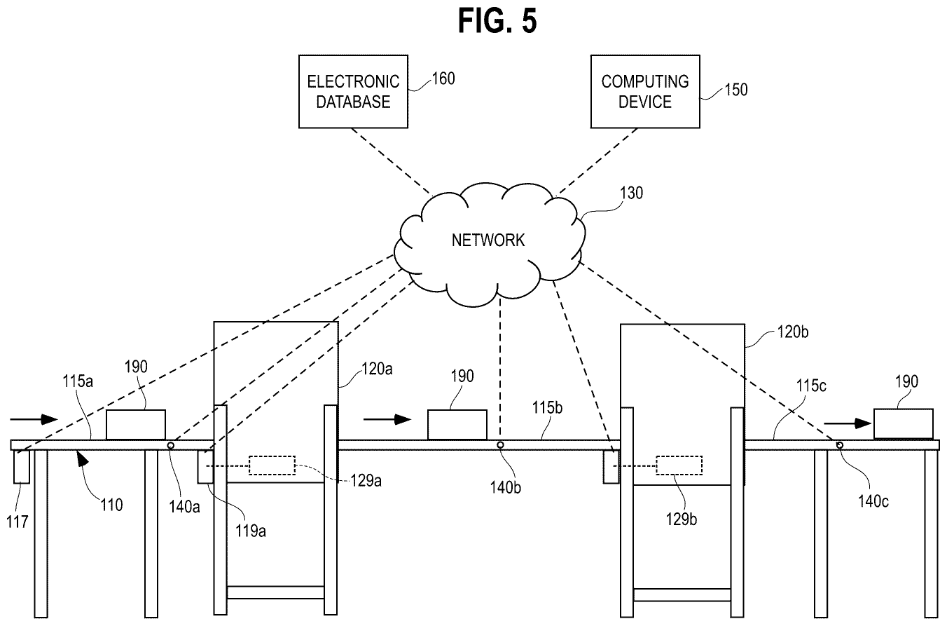

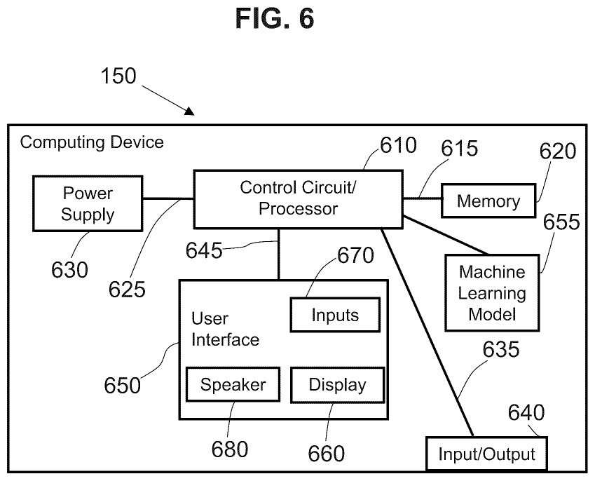

In the illustrated embodiment, to effectuate the directional movement of the product advancement surface 115 of the conveyor 110 and the movement of the containers 190 (or products that are not packaged into containers or products that are not packaged in any packaging) thereon, the example system 100 includes a conveyor control unit 117 (see FIGS. 1 and 5) coupled (e.g., electrically) to the conveyor 110. The conveyor control unit 117 can be located at or near the conveyor 110 as shown in FIG. 1, or may be built into the conveyor 110. In some embodiments, the conveyor control unit 117 is configured to receive a signal from a computing device 150 (which is generally shown in FIG. 5 and described in more detail in FIG. 6) and, in response to receipt of such a signal, to either cause the product advancement surface 115 to move in the direction shown by directional arrows in FIG. 1 (or in an opposite direction or in a direction perpendicular to or diagonal relative to the direction shown by the directional arrows in FIG. 1), or to stop.

In the embodiment shown in FIG. 1, the system 100 includes a first rotation chamber 120a and a second rotation chamber 120b positioned to overlay a portion of the product advancement surface 115 of the conveyor 110 such that the containers 190 moving on the product advancement surface 115 of the conveyor 110 pass through an interior 125a of the first rotation chamber 120a and through an interior 125b of the second rotation chamber 120b. As shown in FIG. 1, each rotation chamber 120a, 120b of the system 100 includes an interior 125a, 125b, respectively, that functions akin to a tunnel and an opening 126a, 126b, respectively, through which the container 190 passes into the interior 125a, 125b of the first rotation chamber 120a, 120b while traveling on the product advancement surface 115 of the conveyor 110.

In FIGS. 1 and 5, for ease of reference, the portion of the product advancement surface 115 located upstream of the first rotation chamber 120a will be referred to as the first portion 115a of the product advancement surface 115, the portion of the product advancement surface 115 located downstream of the first rotation chamber 120a and upstream of the second rotation chamber 120b (i.e., between the first rotation chamber 120a and the second rotation chamber 120b) will be referred to as the second portion 115b of the product advancement surface 115, and the portion of the product advancement surface 115 located downstream of the second rotation chamber 120b will be referred to as the third portion 115c of the product advancement surface 115.

In some embodiments, each of the rotation chambers 120a, 120b rotates in 90-degree increments. In certain aspects, each of the rotation chambers 120a, 120b is capable of rotating only in one direction (e.g., clockwise or counterclockwise), but in other aspects, each of the rotation chambers 120a, 120b is capable of rotating in two directions and may rotate counterclockwise or clockwise as directed (e.g., by a signal transmitted by the computing device 150). In other words, to make a 90-degree rotation in a given direction (e.g., counterclockwise or clockwise), a rotation chamber 120a may make one 90-degree rotation in that direction, to make a 180-degree rotation in a given direction (e.g., counterclockwise or clockwise), the first rotation chamber 120a may make two 90-degree rotations in that direction, to make a 270-degree rotation in a given direction (e.g., counterclockwise or clockwise), a rotation chamber 120a may make three 90-degree rotations in that direction, and to make a 360-degree rotation in a given direction (e.g., counterclockwise or clockwise), a rotation chamber 120a may make four 90-degree rotations in that direction.

In the illustrated embodiment, to effectuate the rotational movement of the rotation chambers 120a, 120b, the example system 100 includes rotation chamber control units 119a, 119b (see FIGS. 1 and 5) coupled (e.g., electrically, hydraulically, etc.) to rotation chambers 120a, 120b, respectively. In some aspects, as shown in FIG. 1, a first rotation chamber control unit 119a can be located at or near (or may be built into) the first rotation chamber 120a and a second rotation chamber control unit 119b can be located at or near (or may be built into) the second rotation chamber 120b. In certain aspects, instead of each of the first and second rotation chambers 120a, 120b being controlled by a separate rotation chamber control unit 119a, 119b, respectively, the system 100 may include a single rotation chamber control unit that may control rotation of both of the first and second rotation chambers 120a, 120b. In some embodiments, the first and second rotation chamber control units 119a, 119b may are configured to receive a signal from the aforementioned computing device 150 and, in response to receipt of such a signal, to cause a respective one of the first and second rotation chambers 120a, 120b to rotate in a direction indicated in the signal.

In some aspects, the interior 125a, 125b of each of the rotation chambers 120a, 120b is configured to rotate in 90-degree increments (e.g., by being operatively coupled to a mechanical, electrical, or hydraulic actuator). In the embodiment shown in FIG. 5, first and second motors 129a, 129b are coupled to each one of the first and second rotation chambers 120a, 120b, respectively. In some aspects, each of these motors 129a, 129b is activated via an activation signal transmitted by the computing device 150 to the rotation chamber control units 119a, 119b over the network 130, which in turn activate the motors 129a, 129b, and this activation of the motors 129a, 129b by the respective rotation chamber control units 119a, 119b causes the rotation chambers 120a, 120b respectively coupled to the motors 129a, 129b to make a 90-degree rotation in a direction indicated in the activation signal.

The example network 130 depicted in FIG. 5 may be a wide-area network (WAN), a local area network (LAN), a personal area network (PAN), a wireless local area network (WLAN), Wi-Fi, Zigbee, Bluetooth (e.g., Bluetooth Low Energy (BLE) network), or any other internet or intranet network, or combinations of such networks. Generally, communication between various electronic devices of system 100 may take place over hard-wired, wireless, cellular, Wi-Fi or Bluetooth networked components or the like.

The example system 100 shown in FIG. 1 for simplicity of illustration with only one conveyor 110, two rotation chambers 120a, 120b, and one container 190 in five different positions and stages of rotation thereon, but it will be appreciated that the system 100 may include two or more conveyors 110 and three or more rotation chambers depending on the size and processing needs of the facility where the system 100 is installed. For example, in one embodiment, the system 100 may include the first rotation chamber 120a (shown in FIG. 1) that rotates in 90-degree increments, the second rotation chamber 120b (shown in FIG. 1) that rotates in 90-degree increments in the same direction as the first rotation chamber 120a, and a third rotation chamber (not shown, but akin to the first and second rotation chambers 120a, 120b shown in FIG. 1) that rotates in 90-degree increments in the same direction as the first and second rotation chambers 120a, 120b. In such an embodiment, the container 190, after passing through and being rotated by the first, second, and third rotation chambers would be rotated by 270 degrees relative to the original (pre-rotation) orientation of the container 190.

In addition, while this application refers to a container 190 and the orientation of the container 190 on a product advancement surface 115 of the conveyor 110, it will be appreciated that the conveyor system 100 may be used to transport and reorient products that are not packaged. Further, the size of the containers 190 in FIG. 1 has been shown by way of example only, and it will be appreciated that the conveyor 110 may transport many different containers 190 (or unpackaged products) having many different sizes and shapes.

In some embodiments, the system 100 includes one or more sensors positioned proximate (e.g., above, below, on the side of) the product advancement surface 115 of the conveyor 110 and configured to detect the presence and/or location of a container (or product) 190 moving on the product advancement surface 115 of conveyor 110, and to generate sensor data indicating at least one of the presence and the location of the container 190 on the product advancement surface 115 of the conveyor 110. In the example embodiment illustrated in FIGS. 1 and 5, the system 100 includes three sensors 140a, 140b, 140c, with the first sensor 140a located adjacent to the first portion 115a of the product advancement surface 115, the second sensor 140b located adjacent to the second portion 115b of the product advancement surface 115, and the third sensor 140c located adjacent to the third portion 115c of the product advancement surface 115. Again, the locations of the sensors 140a-140c relative to the first, second, and third portions 115a-115c of the product advancement surface 115 are shown by way of example only, and it will be understood that the sensors 140a-140c may be disposed at different locations. In some aspects, each of the sensors 140a-140c is a digital camera, but it will be appreciated that each of the sensors 140a-140c may be another sensor (e.g., RGB-D sensor, LiDAR (Light Detection and Ranging) sensors, line-scanning laser, microphone, etc.) suitable to detect the presence and/or orientation of a container 190 traveling on the conveyor 110.

In certain embodiments, while a container 190 is moving on a first portion 115a of the product advancement surface 115 of the conveyor 110 located upstream of the first rotation chamber 120a, the first sensor 140a detects a presence of the container 190 and/or an original (i.e., pre-rotation) orientation of the container 190 travelling on the conveyor 110. In one implementation, after detecting the presence and/or orientation of the container 190 on the first portion 115a of the product advancement surface 115 of the conveyor 110, the first sensor 140a transmits corresponding sensor data indicative of the presence and/or orientation of the container 190 to an electronic database 160 or the computing device 150 via the network 130.

In some aspects, after the container 190 exits from the interior 125a of the first rotation chamber 120a and is moving on a second portion 115b of the product advancement surface 115 of the conveyor 110 located downstream of the first rotation chamber 120a but upstream of the second rotation chamber 120b, the second sensor 140b detects a presence of the container 190 and/or the orientation of the container 190 travelling on the conveyor 110. In one implementation, after detecting the presence and/or orientation of the container 190 on the second portion 115b of the product advancement surface 115 of the conveyor 110, the second sensor 140b transmits corresponding sensor data indicative of the presence and/or orientation of the container 190 to an electronic database 160 or the computing device 150 via the network 130.

In certain aspects, after the container 190 exits from the interior 125b of the second rotation chamber 120b and is moving on a third portion 115c of the product advancement surface 115 of the conveyor 110 located downstream of the first and second rotation chambers 120a, 120b, the third sensor 140c detects a presence of the container 190 and/or the orientation of the container 190 travelling on the conveyor 110. In one implementation, after detecting the presence and/or orientation of the container 190 on the third portion 115c of the product advancement surface 115 of the conveyor 110, the third sensor 140c transmits corresponding sensor data indicative of the presence and/or orientation of the container 190 to an electronic database 160 or the computing device 150 via the network 130.

With reference to FIG. 5, the example system 100 includes an electronic database 160. In some embodiments, the electronic database 160 and the computing device 150 may be implemented as two separate physical devices as shown in FIG. 5. It will be appreciated, however, that the computing device 150 and the electronic database 160 may be implemented as a single physical device. In some aspects, the electronic database 160 may be stored, for example, on non-volatile storage media (e.g., a hard drive, flash drive, or removable optical disk) internal or external to the computing device 150, or internal or external to computing devices distinct from the computing device 150. In some aspects, the electronic database 160 may be cloud-based.

Generally, the example electronic database 160 of FIG. 5 may store data associated with the detection of the containers 190 on the conveyor 110 and the reorientation/rotation of the containers 190 on the conveyor 110. Some example electronic data that may be stored in the electronic database 160 includes, but is not limited to, data corresponding to sensor data captured by the sensors 140a-140c while the containers 190 are moving on the conveyor 110.

As mentioned above, the example system 100 shown in FIG. 5 further includes a computing device 150 configured to communicate with the electronic database 160, the sensors 140a-140c, the conveyor control unit 117, the rotation chamber control units 119a, 119b (and any other electronic components of the system 100) over the network 130. The computing device 150 may be a stationary or portable electronic device, for example, a desktop computer, a laptop computer, a tablet, a mobile phone, or any other electronic device including a control circuit (i.e., control unit) that includes a programmable processor. The computing device 150 may be configured for data entry and processing as well as for communication with other devices of system 100 via the network 130.

As mentioned above, and will be discussed in more detail below, in some embodiments, the computing device 150 is configured to obtain data (e.g., sensor data generated by the first, second, and third sensors 140a-140c) indicating a detection of a container 190 and/or an orientation of the container 190 on the product advancement surface 115 of the conveyor 110. In some aspects, the computing device 150 obtains the sensor data directly from the first, second, and third sensors 140a-140c via the network 130. In other aspects, the computing device 150 obtains the sensor data from the electronic database 160 (i.e., the first, second, and third sensors 140a-140c transmit sensor data to the electronic database 160 over the network 130, after which the computing device 150 obtains the sensor data from the electronic database 160 over the network 130).

In certain aspects, based on the obtained sensor data, the computing device 150 is configured to determine: (1) how many 90-degree rotation of the first and second rotation chambers 120a, 120b are required to reorient the container 190 from the original (pre-rotation) orientation of the container 190 to a desired (i.e., correct/right side up) orientation; (2) which direction (e.g., clockwise or counterclockwise) each one of the rotation chambers 120a, 120b must rotate to reorient the container to the right side up orientation in a fewest number of 90-degree rotations; and (3) which corner of each one of the rotation chambers 120a, 120b the container 190 must enter prior to a first 90-degree rotation of the container 190 from the original orientation of the container 190 to ensure that the container 190 does not tumble from the corner of the first and second rotation chambers 120a, 120b during the 90-degree rotation of the container 190 within the first and second rotation chambers 120a, 120b.

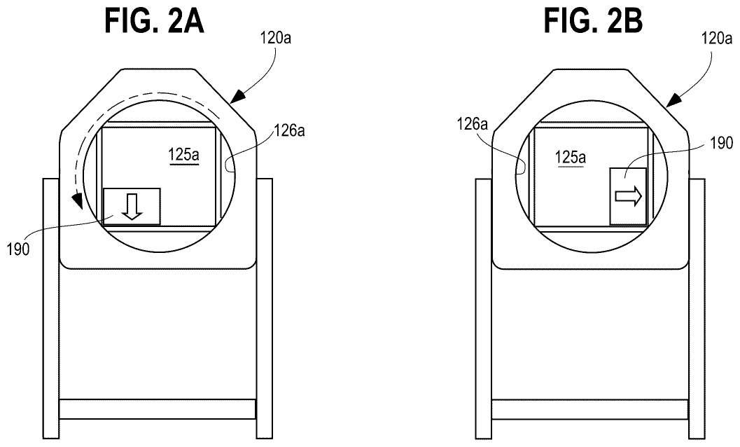

In some implementations, the computing device 150 is configured to transmit, via the network 130, at least one signal to the conveyor control unit 117 to cause the product advancement surface 115 of the conveyor 110 to move the container 190 into the interior 125a, 125b of the rotation chamber 120a, 105b and dispose the container 190 within the inter the interior 125a, 125b of the rotation chamber 120a, 120b at a corner of the interior 125a, 125b of the rotation chamber 120a, 120b determined by the computing device 150 to be the corner, where the container 190, if disposed at prior to rotation of the rotation chamber 120a, 120b, would not tumble from the corner during the 90-degree rotation of the container 190 in the direction predetermined by the computing device 150. Examples of proper alignment of the container 190 with the correct corners of the interior 125a, 125b of the rotation chamber 120a, 120b are illustrated in FIGS. 2A-4B, discussed in more detail below.

As mentioned above, and will be discussed in more detail below, in some aspects, the computing device 150 is configured to transmit, via the network 130, at least one signal to the rotation chamber control unit 119a, 119b to cause a respective rotation chamber 120a, 120b to make a 90-degree rotation in the direction determined by the computing device 150.

With reference to FIG. 6, the example computing device 150 configured for use with example systems and methods described herein may include a control circuit 610 including a programmable processor (e.g., a microprocessor or a microcontroller) electrically coupled via a connection 615 to a memory 620 and via a connection 625 to a power supply 630. The control circuit 610 can comprise a fixed-purpose hard-wired platform or can comprise a partially or wholly programmable platform, such as a microcontroller, an application specification integrated circuit, a field programmable gate array, and so on. These architectural options are well known and understood in the art and require no further description here.

The control circuit 610 can be configured (for example, by using corresponding programming stored in the memory 620 as will be well understood by those skilled in the art) to carry out one or more of the steps, actions, and/or functions described herein. In some embodiments, the memory 620 may be integral to the processor-based control circuit 610 or can be physically discrete (in whole or in part) from the control circuit 610 and is configured non-transitorily store the computer instructions that, when executed by the control circuit 610, cause the control circuit 610 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM)) as well as volatile memory (such as an erasable programmable read-only memory (EPROM))). Accordingly, the memory and/or the control unit may be referred to as a non-transitory medium or non-transitory computer readable medium.

In the illustrated embodiment, the control circuit 610 of the computing device 150 is also electrically coupled via a connection 635 to an input/output 640 that can receive signals from, for example, from the sensors 140a-140c, electronic database 160, and/or from another electronic device. The input/output 640 of the computing device 150 can also send signals to other devices, for example, a signal to the electronic database 160 to obtain sensor data and/or a signal to the conveyor control unit 117 to control movement of the conveyor 110, and/or a signal to the rotation chamber control unit 119a, 119b to control rotation of the rotation chambers 120a, 120b. For example, in some aspects, the control circuit 610 is programmed to process the sensor data (e.g., images captured by the sensors 140a-140c) and to extract raw image data and metadata from the images, and to cause transmission of the raw data extracted from the images to the electronic database 160 for storage. In some aspects, the control circuit 610 may process the images captured by the sensors 140a-140c (e.g., via intrinsics system safety module(s), point cloud accumulation and filtering modules, image segmentation module(s), and inverse kinematic/motion planning modules, machine learning model(s) 655, etc.) to detect objects, shapes, and/or edges of containers 190 in the images and/or to determine the optimal container manipulation (e.g., direction of rotation, number of rotations, etc.) to reorient a container 190 from its initial orientation to a desired orientation.

The processor-based control circuit 610 of the computing device 150 shown in FIG. 6 is electrically coupled via a connection 645 to a user interface 650, which may include a visual display or display screen 660 (e.g., LED screen) and/or button input 670 that provide the user interface 650 with the ability to permit an operator of the computing device 150 (e.g., an operator of the conveyor 110) to manually control the computing device 150 by inputting commands via touch-screen and/or button operation and/or voice commands.

In some aspects, the manual control by an operator of the computing device 150 may be via the user interface 650 of the computing device 150, via another electronic device of the operator, or via another user interface and/or switch, and may include an option to process the images captured by the sensors 140a-140c using a machine learning model 655 to facilitate the object detection, initial container orientation determination, and/or container reorientation requirements to reorient a container 190 right side up. In some aspects, the user interface 650 of the computing device 150 may also include a speaker 680 that provides audible feedback (e.g., alerts) to the operator of the computing device 150. It will be appreciated that the performance of such functions by the control circuit 610 is not dependent on a human operator, and that the control circuit 610 may be programmed to perform such functions without a human operator.

An example of the system 100 in operation will now be described with reference to FIGS. 1-4A. Initially, a container 190 travels on a first portion 115a of the product advancement surface 115 located upstream of the first rotation chamber 120a. As indicated in FIG. 1 by a downwardly-pointing directional arrow on the container 190, this container is originally oriented upside-down, i.e., the container 190 is disposed in an orientation that is 180 degrees opposite of the desired orientation of the container 190, in which the upwardly-pointing arrow would point up. It will be appreciated that the directional arrow, which is shown in FIG. 1 for ease of illustration of the orientation of the container 190 may be physically present on an exterior of the containers 190 moving along the conveyor 190 in some embodiments to enable the system 100 to easily determine the orientation of the container 190 based on the direction pointed by the arrow.

FIG. 1 further shows that the container 190 entered the interior 125a of the first rotation chamber 120a while being in its incorrect original (pre-rotation) orientation with the directional arrow pointing down. FIG. 2A more clearly shows the location of the container 190 within the first rotation chamber 120a. In particular, in the embodiment illustrated in FIGS. 1 and 2A, the first rotation chamber 120a is shown as rotating in the counterclockwise direction (as indicated by the directional arrow in FIGS. 1 and 2A). In order to prevent the undesired tumbling of the container 190 during the 90-degree counterclockwise rotation of the first rotation chamber 120a, the first portion 115a of the product advancement surface 115 of the conveyor 110 advances the container 190 into the interior 125a of the first rotation chamber 120a such that the bottom left corner of the container 190 is positioned adjacent (and in very close proximity) to, and, in some aspects, in direct contact with, the bottom left corner of the first rotation chamber 120a, as seen in FIG. 2A.

When the container 190 is positioned in the bottom left corner of the first rotation chamber 120a as shown in FIG. 2A, when the first rotation chamber 120a makes its 90-degree counterclockwise rotation from the position shown in FIG. 2A to the position shown in 2B, the container 190 is rotated by 90 degrees relative to its initial orientation and ends up in the bottom right corner of the first rotation chamber 120a as shown in FIG. 2B without tumbling during the 90-degree rotation of the first rotation chamber 120a. If, on the other hand, the container 190 were instead incorrectly positioned in the bottom right corner of the first rotation chamber 120a before the first rotation chamber 120a makes its 90-degree counterclockwise rotation from the position shown in FIG. 2A to the position shown in 2B, during the 90-degree rotation of the first rotation chamber 120a, the container 190 would simply tumble out of the bottom right corner of the first rotation chamber 120a due to gravity and would either not rotate as intended or would rotate in the wrong direction.

With reference back to FIG. 1, after the first rotation chamber 120a makes its 90-degree rotation as described above, the container 190 is caused (e.g., by roller wheels, conveyor belt, etc. located in the interior 125a of the first rotation chamber 120a) to exit from the interior 125a of the first rotation chamber 120a and to advance onto the second portion 115b of the product advancement surface 115. As can be seen in FIG. 2A, the container enters the interior 125a of the first rotation chamber 120a such that the bottom left corner of the container 190 is aligned with the bottom left corner of the first rotation chamber 120a, but as a result of the 90-degree rotation of the first rotation chamber 120a, the container 190 ends up in a position, where the bottom right corner of the container 190 is aligned with (and adjacent to) the bottom right corner of the first rotation chamber 120a as shown in FIG. 2B. As a result, when the container 190 exits from the interior 125a of the first rotation chamber 120a and to advance onto the second portion 115b of the product advancement surface 115, the container 190 is initially positioned as shown in FIG. 1 such that the bottom right corner of the container 190 is aligned with the bottom right corner of the second rotation chamber 120b.

In the illustrated embodiment, the second portion 115b of the product advancement surface 115 is configured to reposition the container 190 (in the direction generally shown by the diagonal directional arrow in FIG. 1) from the position where the bottom right corner of the container 190 is aligned with the bottom right corner of the second rotation chamber 120b to a position where bottom left corner of the container 190 is aligned with the bottom left corner of the second rotation chamber 120b. As such, when the container 190 is advanced by the second portion 115b of the product advancement surface 115 into the interior 125b of the second rotation chamber 120b, the container 190 is positioned in the interior 125b of the second rotation chamber 120b such that the bottom left corner of the container 190 is aligned with the bottom left corner of the second rotation chamber 120b as shown in FIG. 1. In some embodiments, the second portion 115b of the product advancement surface 115 includes skewed rollers, omnidirectional wheels, multiple conveyor belts, or mechanical actuators to cause the container 190 to travel in the desired direction (e.g., in the diagonal direction as shown in FIG. 1, or in a forward direction and a perpendicular sideways direction) to properly align the container 190 with the proper corner of the second rotation chamber 120b.

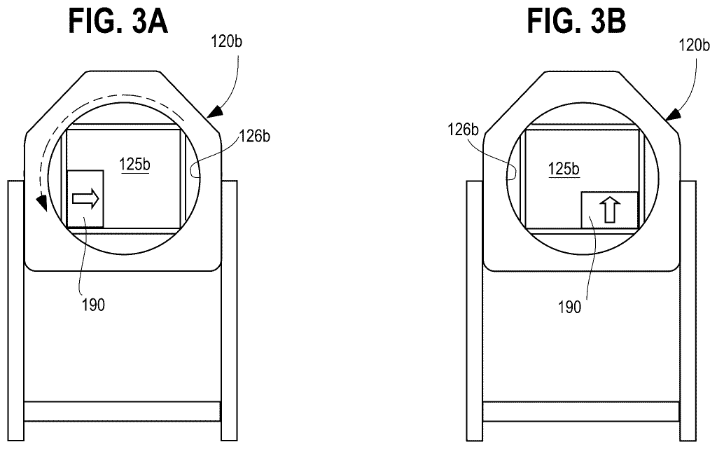

FIG. 3A more clearly shows the location of the container 190 within the second rotation chamber 120b. In particular, in the embodiment illustrated in FIGS. 1 and 3A, like the first rotation chamber 120a, the second rotation chamber 120b is shown as rotating in the counterclockwise direction (as indicated by the directional arrow in FIGS. 1 and 3A). In order to prevent the undesired tumbling of the container 190 during the 90-degree counterclockwise rotation of the second rotation chamber 120b, the first portion 115a of the product advancement surface 115 of the conveyor 110 advances the container 190 into the interior 125b of the second rotation chamber 120b such that the bottom left corner of the container 190 is positioned adjacent (and in very close proximity) to, and, in some aspects, in direct contact with, the bottom left corner of the second rotation chamber 120b, as seen in FIG. 3A.

When the container 190 is positioned in the bottom left corner of the second rotation chamber 120b as shown in FIG. 3A, when the second rotation chamber 120b makes its 90-degree counterclockwise rotation from the position shown in FIG. 3A to the position shown in 3B, the container 190 is rotated by 90 degrees relative to its initial orientation and ends up in the bottom right corner of the second rotation chamber 120B as shown in FIG. 3B without tumbling during the 90-degree rotation of the second rotation chamber 120b. If, on the other hand, the container 190 were instead incorrectly positioned in the bottom right corner of the second rotation chamber 120b before the second rotation chamber 120b makes its 90-degree counterclockwise rotation from the position shown in FIG. 3A to the position shown in 3B, during the 90-degree rotation of the second rotation chamber 120b, the container 190 would simply tumble out of the bottom right corner of the second rotation chamber 120b due to gravity and would either not rotate as intended or would rotate in the wrong direction.

With reference back to FIG. 1, after the second rotation chamber 120b makes its 90-degree rotation as described above, the container 190 is caused (e.g., by roller wheels, conveyor belt, etc. located in the interior 125b of the second rotation chamber 120b) to exit from the interior 125b of the second rotation chamber 120b and to advance onto the third portion 115c of the product advancement surface 115. As can be seen in FIG. 1, when the container 190 exits from the interior 125b of the second rotation chamber 120b, the container 190 is oriented with the right side up, which is evidenced in FIG. 1 by the fact that the directional arrow on the container 190 is pointing in an upwardly direction.

As discussed above, this correct orientation of the container 190 now advancing on the third portion 115c of the product advancement surface 115 is achieved by virtue of two 90-degree rotations of the container 190 (i.e., first rotation in the first rotation chamber 120a and second rotation in the second rotation chamber 120b) relative to its original (pre-rotation) orientation in which the container 190 was when traveling on the first portion 115a of the product advancement surface 115. Notably, as pointed above, if the container 190 were to be initially oriented on the first portion 115a of the product advancement surface 115 such that the container 190 required three 90-degree rotations in the counterclockwise direction to be reoriented right side up, in some embodiments, the system 100 could include a third rotation chamber positioned downstream of the second rotation chamber 120b, and the third portion of the product advancement surface 115 of the conveyor 110 could advance the container 190 into the third rotation chamber, where the container 190 could make another 90-degree rotation in the counterclockwise direction such that, after passing through the three rotation chambers, the container 190 would be reoriented by 270 degrees relative to its initial (pre-rotation) orientation and would be oriented in its desired orientation, where the directional arrow points up.

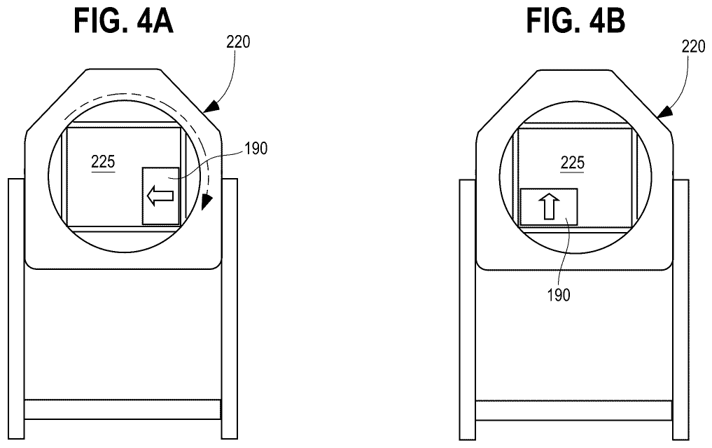

FIGS. 4A and 4B show an example, where a rotation chamber 220 rotates in the clockwise direction instead of the counterclockwise direction in which the first and second rotation chambers 120a, 120b were described as rotating. FIG. 4A shows the location of the container 190 within an interior 225 of the rotation chamber 220. In order to prevent the undesired tumbling of the container 190 within the interior 225 of the rotation chamber 220 during the 90-degree clockwise rotation of the rotation chamber 220, the conveyor 190 is positioned within the interior 225 of the rotation chamber 220 such that the bottom right corner of the container 190 is positioned adjacent (and in very close proximity) to, and, in some aspects, in direct contact with, the bottom right corner of the rotation chamber 220, as seen in FIG. 4A.

When the container 190 is positioned in the bottom right corner of the rotation chamber 220 as shown in FIG. 4A, when the rotation chamber 220 makes its 90-degree clockwise rotation from the position shown in FIG. 4A to the position shown in 4B, the container 190 is rotated by 90 degrees relative to its initial orientation and ends up in the bottom left corner of the rotation chamber 220 as shown in FIG. 4B without tumbling during the 90-degree rotation of the rotation chamber 220. If, on the other hand, the container 190 were instead incorrectly positioned in the bottom left corner of the rotation chamber 220 before the rotation chamber 220a makes its 90-degree clockwise rotation from the position shown in FIG. 4A to the position shown in 4B, during the 90-degree rotation of the rotation chamber 220, the container 190 would simply tumble out of the bottom left corner of the rotation chamber 120a due to gravity and would either not rotate as intended or would rotate in the wrong direction.

As discussed above, in some embodiments, the system includes a computing device 150 with a control circuit 610 that can obtain and process sensor data relating to the position and/or orientation of the container 190 on the conveyor 190, and then determine how many rotations the container 190 needs and in which direction to reorient the container 190 into a desired orientation, as well as determine which corner of the first and second rotation chambers 120a, 120b to direct the container 190 into prior to rotation such that the container 190 does not tumble during the rotation.

Below is an example of a logic flow process associated with the decision-making by the control circuit 610 of the computing device 150 during operation of the system 100 (i.e., while containers 190 are moving on the conveyor 110). In one aspect, as the container 190 is moving on the first portion 115a of the product advancement surface 115, a first sensor 140a may detect the presence and/or physical location and/or orientation of the container 190, generating corresponding sensor data. In some aspects, the control circuit 610 processes this sensor data to determine the orientation of the container 190 and to determine whether the container 190 is oriented with the right side up, or if the container 190 needs to be reoriented to be right side up. If the control circuit 610 determines that the container 190 is oriented with the right side up, the control circuit 610 sends a signal to the conveyor control unit 117 and/or rotation chamber control units 119a, 119b to permit the container 190 to move on the conveyor 110 without being rotated.

If, on the other hand, the control circuit 610 determines that the container 190 is not oriented with the right side up, and requires two 90-degree rotations in the counterclockwise direction (which is the situation depicted in FIG. 1), and the control circuit 610 determines that the first rotation chamber 120a is ready to receive the container 190, the control circuit 610 would generate and cause the transmission by the computing device 150 of a signal to the conveyor control unit 117 to cause the first portion 115a of the product advancement surface 115 to advance the container 190 toward the first rotation chamber 120a, and to align the bottom left corner of the container 190 with the bottom left corner of the first rotation chamber 120a prior to the container 190 entering the interior 125a of the first rotation chamber 120a. If, on the other hand, the control circuit 610 determines that the first rotation chamber 120a is not ready to receive the container 190, the control circuit 610 would generate and cause the transmission by the computing device 150 of a signal to the conveyor control unit 117 to cause the first portion 115a of the product advancement surface 115 to stop and not continue advancing the container 190 toward the first rotation chamber 120a until the first rotation chamber 120a is ready to receive the container 190.

In some embodiments, after the container 190 has entered the interior 125a of the first rotation chamber 120a, the first sensor 140a or another sensor positioned within the interior 125a of the first rotation chamber 120a may detect the presence of the container 190 within the interior 125a of the first rotation chamber 120a, and may generate corresponding sensor data. In some aspects, the control circuit 610 processes this sensor data and confirms that the container 190 is located within the interior 125a of the first rotation chamber 120a, after which the control circuit 610 sends a signal to the rotation chamber control unit 119a to cause the first rotation chamber 120a to make one 90-degree rotation in the counterclockwise direction (as shown in FIGS. 2A-2B, discussed above).

In another embodiment, after the first sensor 140a or another sensor positioned within the interior 125a of the first rotation chamber 120a detects the presence of the container 190 within the interior 125a of the first rotation chamber 120a, the rotation chamber 120a automatically makes its 90-degree rotation in the counterclockwise direction without requiring a separate signal from the control circuit 610 of the computing device 150. For example, in one aspect, the system 100 may include an infeed sensor positioned within the interior 125a of the first rotation chamber 120a to detect the leading edge and the trailing edge of the container 190, such that, when the infeed sensor detects the leading edge of the container 190 within the interior 125a of the first rotation chamber 120a, the infeed sensor activates, and when the infeed sensor detects the trailing edge of the container 190 within the interior 125a of the first rotation chamber 120a, the infeed sensor sends a signal that causes the rollers located within the interior 125a of the first rotation chamber 120a to stop (and restrict further forward movement of the container 190 out of the interior 125a of the first rotation chamber 120a) and to cause first rotation chamber 120a to rotate 90-degrees in the predetermined direction (e.g., via a motor 129a (see FIG. 5), which may be a servo motor). In some aspects, after that, the infeed sensor may turn off (i.e., toggle to the inactive state until the outfeed sensor is again activated by a leading edge of another container 190 moving into the interior 125a of the first rotation chamber 120a).

In some aspects, after the container 190 is rotated by one 90-degree rotation in the counterclockwise direction in the first rotation chamber 120a, the control circuit 610 determines (e.g., by processing sensor data obtained from the second sensor 140b) whether the second portion 115b of the product advancement surface 115 is ready for the container 190. If the control circuit 610 determines that the second portion 115b of the product advancement surface 115 is not ready for the container 190, the control circuit 610 would generate and cause the transmission by the computing device 150 of a signal to the rotation chamber control unit 119a to cause the container 190 to remain in the interior 125a of the first rotation chamber 120a until the control circuit 610 determines that the second portion 115b of the product advancement surface 115 is ready for the container 190.

If, on the other hand, the control circuit 610 determines that the second portion 115b of the product advancement surface 115 is ready for the container 190, the control circuit 610 would generate and cause the transmission by the computing device 150 of a signal (e.g., to the rotation chamber control unit 119a) to cause the container 190 to be advanced (e.g., via rollers located within the interior 125a of the first rotation chamber 120a) from the interior 125a of the first rotation chamber 120a onto the second portion 115b of the product advancement surface 115.

In one aspect, the system 100 may include an outfeed sensor positioned within the interior 125a of the first rotation chamber 120a to detect the leading edge and the trailing edge of the container 190, such that, when the outfeed sensor detects the leading edge of the container 190 moving in a direction out of the interior 125a of the first rotation chamber 120a, the outfeed sensor activates, and when the outfeed sensor detects the trailing edge of the container 190 moving in the direction out of the interior 125a of the first rotation chamber 120a, the outfeed sensor sends a signal that causes the rollers located within the interior 125a of the first rotation chamber 120a to stop (since there is no longer a container 190 located within the interior 125a of the first rotation chamber 120a, and since rotation of the rollers within the interior 125a of the first rotation chamber 120a is no longer needed), after which the outfeed sensor may turn off (i.e., toggle to the inactive state until the outfeed sensor is again activated by a leading edge of another container 190) moving out of the interior 125a of the first rotation chamber 120a.

As mentioned above, the second portion 115b of the product advancement surface 115 is configured to reposition the container 190 (in the direction generally shown by the diagonal directional arrow in FIG. 1) from the position where the bottom right corner of the container 190 is aligned with the bottom right corner of the second rotation chamber 120b to a position where bottom left corner of the container 190 is aligned with the bottom left corner of the second rotation chamber 120b. To that end, after the control circuit 610 determines (e.g., by processing sensor data obtained from the second sensor 140b) that the container is now located on the second portion 115b of the product advancement surface 115, the control circuit 610 transmits a signal to the conveyor control unit 170a to cause the second portion 115b of the product advancement surface 115 to advance the container 190 in the desired direction (e.g., in the diagonal direction as shown in FIG. 1, or in a forward direction and a perpendicular sideways direction) to properly align the bottom left corner of the container 190 with the bottom left corner of the second rotation chamber 120b, which, as discussed above, is the proper alignment of the corner of the container 190 with the corner of the second rotation chamber 120b to prevent the container 190 from undesirably tumbling during the 90-degree rotation of the second rotation chamber 120b in the counterclockwise direction.

In one aspect, as the container 190 is moving on the second portion 115b of the product advancement surface 115, the second sensor 140b may detect the presence and/or physical location and/or orientation of the container 190, generating corresponding sensor data. In some aspects, the control circuit 610 processes this sensor data to determine the orientation of the container 190 and to determine whether the container 190 is oriented with the right side up, or if the container 190 needs to be reoriented to be right side up. If the control circuit 610 determines that the container 190 is oriented with the right side up, the control circuit 610 sends a signal to the conveyor control unit 117 and/or rotation chamber control unit 119b to permit the container 190 to move on the conveyor 110 through the second rotation chamber 120b without being rotated therein.

If, on the other hand, the control circuit 610 determines that the container 190 is not oriented with the right side up, and still requires one more 90-degree rotation in the counterclockwise direction (which is the situation depicted in FIG. 1), and the control circuit 610 determines that the second rotation chamber 120b is ready to receive the container 190, the control circuit 610 would generate and cause the transmission by the computing device 150 of a signal to the conveyor control unit 117 to cause the second portion 115b of the product advancement surface 115 to advance the container 190 toward the second rotation chamber 120b, and to align the bottom left corner of the container 190 with the bottom left corner of the second rotation chamber 120b prior to the container 190 entering the interior 125b of the second rotation chamber 120b. If, on the other hand, the control circuit 610 determines that the second rotation chamber 120b is not ready to receive the container 190, the control circuit 610 would generate and cause the transmission by the computing device 150 of a signal to the conveyor control unit 117 to cause the second portion 115b of the product advancement surface 115 to stop and not continue advancing the container 190 toward the second rotation chamber 120b until the second rotation chamber 120b is ready to receive the container 190.

In some embodiments, after the container 190 has entered the interior 125b of the second rotation chamber 120b, the second sensor 140b or another sensor positioned within the interior 125b of the second rotation chamber 120b may detect the presence of the container 190 within the interior 125b of the second rotation chamber 120b, and may generate corresponding sensor data. In some aspects, the control circuit 610 processes this sensor data and confirms that the container 190 is located within the interior 125b of the second rotation chamber 120b, after which the control circuit 610 sends a signal to the rotation chamber control unit 119b to cause the second rotation chamber 120b to make one 90-degree rotation in the counterclockwise direction (as shown in FIGS. 3A-3B, discussed above).

In another embodiment, after the second sensor 140b or another sensor positioned within the interior 125b of the second rotation chamber 120b detects the presence of the container 190 within the interior 125b of the second rotation chamber 120b, the second rotation chamber 120b automatically makes its 90-degree rotation in the counterclockwise direction without requiring a separate signal from the control circuit 610 of the computing device 150. For example, in one aspect, the system 100 may include an infeed sensor positioned within the interior 125b of the second rotation chamber 120b to detect the leading edge and the trailing edge of the container 190, such that, when the infeed sensor detects the leading edge of the container 190 within the interior 125b of the second rotation chamber 120b, the infeed sensor activates, and when the infeed sensor detects the trailing edge of the container 190 within the interior 125b of the second rotation chamber 120b, the infeed sensor sends a signal that causes the rollers located within the interior 125b of the second rotation chamber 120b to stop (and restrict further forward movement of the container 190 out of the interior 125b of the second rotation chamber 120b) and to cause second rotation chamber 120b to rotate 90-degrees in the predetermined direction (e.g., via a motor 129b (see FIG. 5), which may be a servo motor). In some aspects, after that, the infeed sensor may turn off (i.e., toggle to the inactive state until the outfeed sensor is again activated by a leading edge of another container 190 moving into the interior 125b of the second rotation chamber 120b).

In some aspects, after the container 190 is rotated by one 90-degree rotation in the counterclockwise direction in the second rotation chamber 190b, the control circuit 610 determines (e.g., by processing sensor data obtained from the third sensor 140c) whether the third portion 115c of the product advancement surface 115 is ready for the container 190. If the control circuit 610 determines that the third portion 115c of the product advancement surface 115 is not ready for the container 190, the control circuit 610 would generate and cause the transmission by the computing device 150 of a signal to the rotation chamber control unit 119b to cause the container 190 to remain in the interior 125b of the second rotation chamber 120b until the control circuit 610 determines that the third portion 115c of the product advancement surface 115 is ready for the container 190. If, on the other hand, the control circuit 610 determines that the third portion 115c of the product advancement surface 115 is ready for the container 190, the control circuit 610 would generate and cause the transmission by the computing device 150 of a signal (e.g., to the rotation chamber control unit 119b) to cause the container 190 to be advanced (e.g., via rollers located within the interior 125b of the second rotation chamber 120b) from the interior 125b of the second rotation chamber 120b onto the third portion 115c of the product advancement surface 115.

In one aspect, the system 100 may include an outfeed sensor positioned within the interior 125b of the second rotation chamber 120b to detect the leading edge and the trailing edge of the container 190, such that, when the outfeed sensor detects the leading edge of the container 190 moving in a direction out of the interior 125b of the second rotation chamber 120b, the outfeed sensor activates, and when the outfeed sensor detects the trailing edge of the container 190 moving in the direction out of the interior 125b of the second rotation chamber 120b, the outfeed sensor sends a signal that causes the rollers located within the interior 125b of the second rotation chamber 120b to stop (since there is no longer a container 190 located within the interior 125b of the second rotation chamber 120b, and since rotation of the rollers within the interior 125b of the second rotation chamber 120b is no longer needed), after which the outfeed sensor may turn off (i.e., toggle to the inactive state until the outfeed sensor is again activated by a leading edge of another container 190) moving out of the interior 125b of the second rotation chamber 120b.

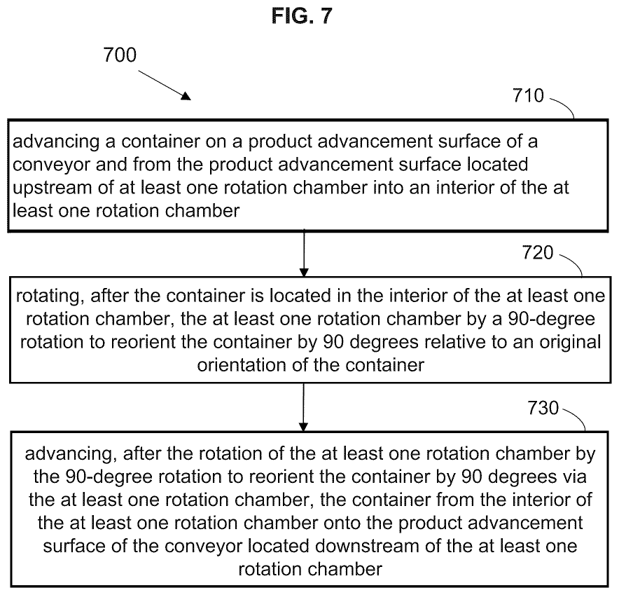

FIG. 7 is a flow chart depicting an example method 700 of reorienting containers moving on conveyors. In the embodiment illustrated in FIG. 7, step 710 of the method 700 includes advancing a container on a product advancement surface of a conveyor and advancing the container from the product advancement surface located upstream of at least one rotation chamber into an interior of the at least one rotation chamber. After the container is advanced on the product advancement surface into the interior of a rotation chamber, step 720 of the method 700 includes rotating the rotation chamber by a 90-degree rotation to reorient the container by 90 degrees relative to an original orientation of the container. Finally, after the 90-degree rotation of the rotation chamber and the resulting reorientation of the container by 90 degrees relative to its original orientation, step 730 of the method 700 includes advancing the container from the interior of the rotation chamber onto the product advancement surface of the conveyor located downstream of the at least one rotation chamber. As mentioned above, in some aspects, two or more rotation chambers may be positioned along the product advancement surface of the conveyor, such that, while moving on the conveyor, the container may pass through two or more rotation chambers and may rotate by 180 degrees relative to its initial (pre-rotation) orientation (if the container passes through two rotation chambers) or by 270 degrees relative to its initial (pre-rotation) orientation (if the container passes through three rotation chambers.

The apparatuses, systems, and methods described above provide a highly efficient and automated solution for reorienting containers on conveyors, addressing the limitations of traditional methods that rely on human labor or robotic arms. By utilizing rotation chambers that rotate boxes in 90-degree increments, the system ensures that containers are consistently positioned with the correct side up, minimizing the risk of errors and reducing operational costs. In addition, the integration of sensors to detect box orientation and control rotation eliminates the need for manual intervention and allows for quick, accurate adjustments, improving productivity and processing speed. Additionally, the ability to utilize multiple rotation chambers in series allows for greater flexibility in achieving the desired orientation, making the system adaptable to a wide range of packaging needs.

Those skilled in the art will recognize that a wide variety of other modifications, alterations, and combinations can also be made with respect to the above-described embodiments without departing from the scope of the disclosure, and that such modifications, alterations, and combinations are to be viewed as being within the ambit of the inventive concept.

1. A system for reorienting containers moving on conveyors, the system comprising:
a conveyor including a product advancement surface that supports a container thereon to advance the container in at least a first direction; and
at least one rotation chamber that rotates in 90-degree increments;
wherein:
the container travels on the product advancement surface of the conveyor located upstream of the at least one rotation chamber and into an interior of the at least one rotation chamber;
after the container is located in the interior of the at least one rotation chamber, the at least one rotation chamber makes a 90-degree rotation to reorient the container by 90 degrees relative to an original orientation of the container; and
after the at least one rotation chamber makes the 90-degree rotation to reorient the container by 90 degrees, the at least one rotation chamber advances the container from the interior of the at least one rotation chamber onto the product advancement surface of the conveyor located downstream of the at least one rotation chamber.

2. The system of claim 1, wherein:
the at least one rotation chamber includes a first rotation chamber and a second rotation chamber;
the first rotation chamber and the second rotation chamber rotate in 90-degree increments in one direction, a direction of rotation of the first rotation chamber and the second rotation chamber being same; and
the container, after passing through and being rotated by the first rotation chamber and the second rotation chamber, being rotated by 180 degrees relative to the original orientation of the container.

3. The system of claim 2, wherein:
the at least one rotation chamber further includes a third rotation chamber that rotates in 90-degree increments in the direction of rotation of the first rotation chamber and the second rotation chamber; and
the container, after passing through and being rotated by the first rotation chamber, the second rotation chamber, and the third rotation chamber being rotated by 270 degrees relative to the original orientation of the container.

4. The system of claim 1, wherein the conveyor includes skewed rollers, omnidirectional wheels, or mechanical actuators to cause the container to travel on the product advancement surface in at least a second direction perpendicular to the first direction or diagonal relative to the first direction.

5. The system of claim 1, further comprising:
a first sensor to detect the original orientation of the container traveling on the product advancement surface upstream of the first rotation chamber, the first sensor to detect the original orientation of the container prior to the container entering the at least one rotation chamber; and
a second sensor to detect an orientation of the container traveling on the product advancement surface downstream of the at least one rotation chamber, the second sensor to detect an orientation of the container after the container exits the at least one rotation chamber.

6. The system of claim 5, wherein each of the first sensor and the second sensor is a camera.

7. The system of claim 5, further comprising a processor-based computing device in communication with the first and second sensors, wherein the computing device obtains sensor data from the first sensor and from the second sensor, and, based on the obtained sensor data, to determine how many 90-degree rotations are required to reorient the container from the original orientation to a right side up orientation.

8. The system of claim 7, wherein the computing device, based on the obtained sensor data, determines:
which direction the at least one rotation chamber must rotate to reorient the container to the right side up orientation in a fewest number of 90-degree rotations; and
which corner of the at least one rotation chamber the container must enter prior to a first 90-degree rotation of the container from the original orientation of the container to ensure that the container does not tumble from the corner during the first 90-degree rotation of the container within the at least one rotation chamber.

9. The system of claim 8, wherein the computing device transmits at least one signal to cause at least one of:
a conveyor control unit operatively coupled to the product advancement surface of the conveyor to move the conveyor such that a bottom corner of the conveyor is aligned with the corner of the at least one rotation chamber determined by the computing device; and
a rotation chamber control unit operatively coupled to the at least one rotation chamber to make the 90-degree rotation in the direction determined by the computing device.

10. The system of claim 9, further comprising a motor coupled to the at least one rotation chamber, wherein the motor is activated by the rotation chamber control unit in response to the signal transmitted by the computing device to cause the at least one rotation chamber to make the 90-degree rotation in the direction determined by the computing device.

11. A method of reorienting containers moving on conveyors, the method comprising:
advancing in a first direction a container on a product advancement surface of a conveyor and from the product advancement surface located upstream of at least one rotation chamber into an interior of the at least one rotation chamber;
rotating, after the container is located in the interior of the at least one rotation chamber, the at least one rotation chamber by a 90-degree rotation to reorient the container by 90 degrees relative to an original orientation of the container; and
advancing, after the rotation of the at least one rotation chamber by the 90-degree rotation to reorient the container by 90 degrees via the at least one rotation chamber, the container from the interior of the at least one rotation chamber onto the product advancement surface of the conveyor located downstream of the at least one rotation chamber.

12. The method of claim 11, wherein the at least one rotation chamber includes a first rotation chamber and a second rotation chamber, and further comprising rotating the first rotation chamber and the second rotation chamber in 90-degree increments in one direction, a direction of rotation of the first rotation chamber and the second rotation chamber being same, wherein the container, after passing through and being rotated by the first rotation chamber and the second rotation chamber, being rotated by 180 degrees relative to the original orientation of the container.

13. The method of claim 12, wherein the at least one rotation chamber further includes a third rotation chamber, and further comprising rotating the third rotation chamber in a 90-degree increment in the direction of rotation of the first rotation chamber and the second rotation chamber, wherein the container, after passing through and being rotated by the first rotation chamber, the second rotation chamber, and the third rotation chamber is rotated by 270 degrees relative to the original orientation of the container.

14. The method of claim 11, wherein the conveyor includes skewed rollers, omnidirectional wheels, or mechanical actuators, and further comprising causing the container to travel on the product advancement surface in at least a second direction perpendicular to the first direction or diagonal relative to the first direction.

15. The method of claim 11, further comprising:
detecting, by a first sensor, the original orientation of the container traveling on the product advancement surface upstream of the first rotation chamber prior to the container entering the at least one rotation chamber; and
detecting, by a second sensor, an orientation of the container traveling on the product advancement surface downstream of the at least one rotation chamber after the container exits the at least one rotation chamber.

16. The method of claim 15, wherein each of the first sensor and the second sensor is a camera.

17. The method of claim 15, further comprising:
by a processor-based computing device in communication with the first and second sensors, obtaining sensor data from the first sensor and from the second sensor; and
determining, based on the obtained sensor data, how many 90-degree rotations are required to reorient the container from the original orientation to a right side up orientation.

18. The method of claim 17, further comprising, by the computing device and based on the obtained sensor data:
determining which direction the at least one rotation chamber must rotate to reorient the container to the right side up orientation in a fewest number of 90-degree rotations; and
determining which corner of the at least one rotation chamber the container must enter prior to a first 90-degree rotations of the container from the original orientation of the container to ensure that the container does not tumble from the corner during the first 90-degree rotations of the container within the at least one rotation chamber.

19. The method of claim 18, further comprising, by the computing device, transmitting at least one signal to cause at least one of:
a conveyor control unit operatively coupled to the product advancement surface of the conveyor to move the conveyor such that a bottom corner of the conveyor is aligned with the corner of the at least one rotation chamber determined by the computing device; and
a rotation chamber control unit operatively coupled to the at least one rotation chamber to make the 90-degree rotation in the direction determined by the computing device.

20. The method of claim 19, further comprising, by the rotation chamber control unit, activating a motor coupled to the at least one rotation chamber in response to the signal transmitted by the computing device to cause the at least one rotation chamber to make the 90-degree rotation in the direction determined by the computing device.
